(19) United States
(12) Patent Application Publication
(10) Pub. No.: US 2012/0039685 A1
(43) Pub. Date: Feb. 16, 2012

(54) SCREW ELEMENT, SCREW CONNECTION AND METHOD FOR PRODUCING A SCREW ELEMENT

(76) Inventor: Winfried K.W. Holscher, Engen (DE)

(21) Appl. No.: 13/144,711

(22) PCT Filed: Jan. 15, 2010
(86) PCT No.: PCT/EP2010/000202

§ 371 Date: Oct. 27, 2011

(30) Foreign Application Priority Data
Jan. 16, 2009 (DE) 10 2009 005 336.0

(51) Int. Cl. F16B 39/28; B21K 1/56

(52) U.S. Cl. 411/263; 72/372

(57) ABSTRACT

A method for manufacturing a screw element (1) with a first external thread section (3) and with a second external thread section (5), wherein the screw element (1) to be manufactured is characterized in that the second external thread section (5) is positioned relative to the first external thread section (3) in such a way as to yield a braking torque when tightening the two external thread sections (3, 5) with an internal thread element (13), with the following procedural steps: the first and second external thread section (3, 5) are positioned relative to each other in such a way as to yield the braking torque while tightening the two external thread sections (3, 5) with an internal thread element (13), wherein the external thread sections (3, 5) are positioned via a defined, relative adjustment of the external thread sections (3, 5) in an axial direction and/or circumferential direction, wherein the first external thread (3) is fabricated at a compression molded first axial section (17), and the second external thread section (5) is fabricated at a second axial section (16) of a screw element blank (14) adjacent to the first axial section (17), and wherein the first axial section (17) is compression molded out of a reduced-diameter screw element blank section (15) by compression molding in the direction of a second axial section (16), in such a way that the diameter of the first axial section (17) corresponds to the diameter of the second axial section (16).

### BACKGROUND OF THE INVENTION

The invention relates to a method for manufacturing a screw element, a screw element with a first external thread section and a second external thread section, as well as a screw connection.

The problem in conventional screws with a single external thread section is that the screw can loosen over time, for example as the result of operational vibrations involving a device provided with the screw. This can have consequences relevant to safety.

Known in addition to the simple screws described above are so-called safety screws designed as differential thread screws. Screws with a differential thread make it possible to securely fasten assemblies, wherein tightening the screw with an internal thread element yields a braking torque that ensures the safety function. The generated braking torque can be attributed to the fact that the screw exhibits two different external thread sections having the same direction of spiral, but a varying pitch. If such a differential thread screw is tightened with an internal thread, the external thread sections become warped with the internal thread. In known differential thread screws, the two external thread sections usually merge directly into each other. The disadvantage to known differential thread screws is the high outlay involved in their manufacture.

DE 490 889 discloses a screw nut (not a screw element) that can safeguard itself against unintended loosening. For this purpose, the known screw nut exhibits two internal thread sections spaced apart in an axial direction, wherein a continuous, internal puncture is introduced between the internal thread sections via machining. The braking effect can be attributed to the fact that the two internal thread sections are axially moved toward each other after the puncture has been introduced, thereby realizing a jump in the internal thread pitch ensuring that the internal thread sections become axially (somewhat) warped in the threads of the external thread element when tightened with a matching external thread element. The disadvantage to the thread nut is that the latter must necessarily be fabricated by machining.

Known from DE 904 013 B is a screw element with two external thread sections offset relative to each other, wherein the external threads of the external thread sections are introduced into a screw blank one after the other.

Known from DE 25 27 557 A1 is a screw with two axially offset external thread sections, wherein the external thread sections are introduced simultaneously, but by means of a rolling die having a special thread, which exhibits two fields correspondingly axially offset relative to each other, with depressions and elevations for introducing the thread grooves.

DE 213 668 B also describes a screw with two axially offset external thread sections.

Among other things, the disadvantage to the known screw elements is that they are not designed for repeated use. Tightening the known screw elements with an internal thread element leads to a plastic, i.e., irreversible, deformation. In addition, known screw elements tend to seize up, thereby damaging the threads. Further, production-related tolerances for the internal thread element cannot be offset with the known screw elements, possibly resulting in a situation where the torque either is entirely absent or exceeds a maximum permissible value, depending on the tolerance (too high or low).

### SUMMARY OF THE INVENTION

The object of the invention is to indicate a method for easily manufacturing a safety screw element, as well as a screw element that can be used as a safety screw, and manufactured using the method according to the invention. In addition, the object is to indicate a screw connection with at least one correspondingly optimized screw element.

This object is achieved in terms of the method, the screw element, and the screw connection as disclosed herein. Advantageous further developments of the invention are indicated as well. The framework of the invention encompasses all combinations of at least two characteristics disclosed in the specification, claims and/or figures. To avoid repetition, features cited in relation to the device will be regarded as disclosed and claimed with respect to the method. In addition, features disclosed in relation to the method will be regarded as disclosed and claimed with respect to the device.

The invention presents a method for manufacturing a (safety) screw element that is described later. The method is characterized in that a first and second external thread section of a screw element blank are positioned relative to each other in such a way as to yield a braking torque when tightening the two external thread sections together with an internal thread element.

According to the invention, the external thread sections are positioned via the defined, relative adjustment of the external thread sections in an axial direction and/or circumferential direction.

The screw element according to the invention is preferably stretched to ensure the braking torque, i.e., the two finished external thread sections are adjusted away from each other in an axial, plastic manner, so that when used as intended, meaning tightened with an internal thread element, the screw element is compressed, specifically in preferably an elastic manner, thereby eliminating the play of the thread in the tensile direction of the screw element, and resulting in a braking torque effect.

As explained previously, it is very much especially preferred that a screw element blank be initially fabricated, preferably via compression molding, very much especially preferred via cold flow compression molding, wherein the screw element blank exhibits a preferably cylindrical screw element blank section, in particular at the end, which is situated adjacent to an axial section. The screw element blank section preferably differs from the adjacent (second) axial section with respect to the size of its diameter. It is further preferred that in particular the end side of the screw element blank section exhibit a smaller diameter than the adjacent (second) axial section. The screw element blank section is preferably compression molded in an ensuing fabrication step, preferably cold flow compression molded, preferably in such a way that the screw element blank section produces a first axial section after the compression molding process having a diameter that at least approximately, and preferably precisely, corresponds to the diameter of the second axial section. The first external thread section is manufactured either in a subsequent fabrication step or concurrently with the production of the first axial section out of the screw element blank section at the first axial section. As will also be explained below, the external thread is thus also introduced into the second axial section, preferably simultaneously with the fabrication of the first external thread section, meaning at the same time (i.e., in a single operation) the external thread is incorporated into the first axial section.

With respect to realizing the compression molding process (in particular the cold flow compression molding process) for enlarging the diameter of the first axial section, it is preferred that the screw element blank section be compression molded in such a way that the resultant first axial section also directly abuts the second axial section in a radially outer area.

As explained previously, it is very much especially preferred that the external thread of the first external thread section be introduced in the screw element blank as the external thread of the second external thread section during the same operation, preferably via compression molding or rolling. It is further preferred that the thread be introduced into both axial sections at the same time the first axial section is being compression molded, so as to simultaneously fabricate the external thread sections. As also already explained above, the diameter of the first axial section prior to compression molding, meaning as a screw element blank section, is smaller than the diameter of the second axial section, wherein the diameter of the screw element blank section approaches the diameter of the second axial section as compression molding continues, thereby creating the first axial section. In other words, the first axial section is compression molded out of a reduced-diameter screw element blank section, preferably an end-side screw element blank section, wherein compression molding is to be realized in such a way that no axial distance is left behind after the compression molding process between the axial sections preferably already provided with an external thread, so that the axial sections frontally abut over their entire surface.

The embodiment of the method described above, in which the two axial sections axially (frontally) abut each other after the screw element blank has been compression molded, in particular cold flow compression molded, is especially preferred, since a screw element with minimal axial extension can be fabricated as a result. In other words, the described procedure makes it possible to minimize the axial expansion of the gap to be created between the external thread sections. The axial extension of this axial gap (after axially adjusting the external thread sections) between the external thread sections preferably measures less than 2 mm, even more preferably less than 1 mm, and even more preferably less than 0.6 mm. It is very much especially preferred that the external thread sections be axially adjusted away from each other until the selected axial extension of the gap ranges between roughly 0.1 mm and 0.5 mm. The axial extension of the gap (circumferential groove) here preferably corresponds to the axial extension of the connecting section that joins the two external thread sections with each other.

The diameter selected for the preferably cylindrical contoured connecting section that joins the external thread sections together as a single piece is preferably such that the screw element exhibits a dynamic behavior. In other words, the chosen diameter for the connecting section allows the screw element to axially and elastically deform (compress) while being tightened with an internal screw element, meaning that the screw element is reversibly axially deformable. In this way, the screw element can be used repeatedly, and it is not prone to seize. In addition, a comparatively large production tolerance range for the internal thread element can be offset, so that impermissible (too large or small) braking torques are largely precluded.

It has proven especially advantageous for the diameter of the connecting section axially joining the external thread sections to measure at most 75% of the diameter, in particular the core diameter, of the external thread sections, which preferably exhibit the same diameter, in particular core diameter. It is especially advantageous for the diameter of the connecting section to measure about 20% to 75% of the diameter of the external thread sections, and even more preferred for the diameter of the connecting section to measure about 25% to 50% of the diameter of the external thread sections.

It especially makes sense for the connecting section to be designed in such a way as to enable an elastic adjustment of the two external thread sections toward each other within a range of about 0.05 mm to 0.4 mm, very much especially preferred between 0.1 mm and 0.3 mm.

For example, the axial sections can be axially adjusted relative to each other by screwing an internal thread onto the first external thread section, and clamping in the screw portion that exhibits the second external thread section, wherein the two axial sections are moved a defined distance away from each other (preferably 0.1 mm to 0.5 mm) in an ensuing step by applying a defined axial force, for example by means of a piston cylinder unit, preferably a hydraulic piston cylinder unit.

Additionally or alternatively to axially adjusting the external thread sections, the latter can also be twisted relative to each other in the circumferential direction, making sure that no (excessive) material weakening results during the twisting process.

The axial sections are axially adjusted away from each other, in particular for fabricating a screw element that can be exposed to tensile stress.

In the screw element according to the invention, the braking torque (holding or safety torque) is realized by positioning at least two, preferably only two, external thread sections of the screw element in such a way as to trigger the braking torque, so as to obtain a self-retaining screw element. In other words, the braking torque cannot be attributed, at least not entirely, to the special configuration of the external threaded sections as such in a screw element designed based on the concept underlying the invention, but rather to their relative position. As will be explained further below, the external thread sections can be positioned relative to each other through axial adjustment and/or adjustment in a circumferential direction in such a way that tightening the external thread sections with a shared internal thread element results in a braking torque. The ability to design the external thread sections according to the invention identically, except in terms of their length if needed, makes it significantly easier to manufacture the screw element. In addition, a defined positioning process, for example involving a defined adjustment of the axial sections relative to each other, makes it possible during production to reproducibly (without machining) generate a braking torque of a defined magnitude for all screw elements to be fabricated.

It makes sense especially for the connecting section, which joins the two external thread sections together and spaces them apart from each other, and is designed as a single piece with the external thread sections, to only be so thick as to permit an elastic compression, preferably by at least 0.05 mm, even more especially preferred by at least 0.1 mm, and even more preferably by 0.2 mm, even more preferably by at least 0.3 mm. The ability of the screw element to elastically compress in the area of the connecting section ensures that the screw element designed based on the concept underlying the invention can be used repeatedly without any (discernible) loss in braking torque being noted in the process. The elastic compression of the screw element while tightening the screw element with the internal thread element corresponding to the external thread sections eliminates the play of the thread in the tensile direction of the screw connection. Its elastic compressibility makes the screw element according to the invention suitable for offsetting production-related tolerances for the internal thread element, and ensures a comparably constant braking torque in a comparatively large tolerance range.

The gap (circumferential groove) selected between the two external thread sections, meaning the length of the connecting section, is preferably only somewhat larger than the play of the thread for the screw connection to be fabricated. It is very much especially preferred for the axial extension of the gap to measure less than 2 mm, even more preferably less than 1 mm, and especially preferably less than 0.6 mm. It makes sense especially for the selected axial extension of the gap to measure between about 0.1 mm and 0.5 mm. The minimal axial extension of the gap also yields a minimal axial extension of the entire screw element, so that material can be economized on the one hand, and the corresponding internal thread element can be realized with a minimized axial extension on the other. In particular in applications where the design precludes the realization of a larger axial extension, the small axial extension of the gap offers significant advantages.

The minimal gap is preferably obtained by initially compression molding, in particular cold flow compression molding, a screw element blank to produce the two axial sections with the same diameter. It is here especially preferred for the axial sections to abut each other directly after (cold flow) compression molding. The external threads are introduced into the axial sections in the same step, or preferably in an ensuing step, preferably in a combined procedural step.

In any event, the finished external thread sections, i.e., the axial sections provided with external threads, are then removed from each other to form the gap, specifically preferably spaced less than 2 mm, even more preferably less than 1 mm, very much especially preferred less than 0.6 mm apart, thereby yielding the screw element with its minimal axial extension.

It makes sense especially for the diameter of the preferably cylindrically contoured connecting section to measure only about 20% to about 75% of the diameter, in particular the core diameter, of the external thread sections. It is very much especially preferred that the diameter of the connecting section measure only about 25% to 50% of the diameter, in particular the core diameter, of the external thread sections, which preferably exhibit the same diameter.

There are various options with regard to the specific design of the screw element. It is very much especially preferred for an embodiment of the screw element (safety screw) to be designed as a head screw or setscrew.

It is very much especially preferred to have an embodiment of the screw element in which the braking torque is realized by spacing a thread run-out of the first, preferably end-side external thread section apart from a thread lead-in of the second, axially adjacent external thread section in such a way as to realize a jump in thread pitch between the external threaded sections. In other words, the two external thread sections preferably exhibiting the same thread pitch are positioned in such a way that the threads of the external thread sections do not precisely align with each other in the direction of thread spiral, so that as soon as the second external thread section interacts with a matching internal thread element, the warping between the threads in the tightening process yields a braking torque.

For example, the jump in thread pitch can be realized by spacing the thread run-out of the first external thread section axially correspondingly far apart from the thread lead-in of the second external thread section. During production, an axial relative shifting of the external thread sections relative to each other preferably automatically spaces the thread run-out of the first external thread section apart from the thread lead-in of the second external thread section. It is also possible to twist the external thread sections relative to each other while fabricating the screw element, thereby displacing the thread run-out of the first external thread section relative to the thread lead-in of the second external thread section. The magnitude selected for the axial displacement or displacement in the circumferential direction can be used to adjust the magnitude of the braking torque.

The external thread sections are preferably positioned relative to each other while fabricating the screw element in such a way that the adjusted axial distance between the external thread sections, more accurately between a thread run-out of the first external thread section and a thread lead-in of a second thread section, does not precisely correspond to the thread pitch of the external thread sections, and does not precisely correspond to an integral multiple of the thread pitch of the external thread sections. If this were the case, the screw element could be tightened with an internal thread element by means of both external thread sections without the effect of a braking torque. The thread pitch involves the axial distance by which an external thread section is adjusted given a complete rotation of the screw element in an internal thread element.

An embodiment of the screw element in which the two external thread sections each encompass a metric external thread is very much especially preferred.

As already indicated at the outset, it is especially preferred for the pitch and/or thread size of the two external thread sections to be identical. It is very much especially preferred for both external thread sections to exhibit the same thread, wherein the external thread sections can differ in terms of their axial extension. Also realizable, of course, is an embodiment in which the external thread sections differ with respect to at least one thread parameter, for example the thread pitch. However, it is preferred that the identical threads be provided on both external thread sections.

It especially makes sense for the two external thread sections to be positioned relative to each other via relative adjustment in an axial and/or circumferential direction so as to generate the desired braking torque (safety torque).

The invention also presents a screw connection that comprises a screw element of the kind designed as described above, whose two external thread sections are tightened with a matching internal thread element. A jump in thread pitch is preferably realized here between two external thread sections, so that axial warping in the threads takes arises once the second external thread section has been tightened in the internal thread element.

### BRIEF DESCRIPTION OF THE DRAWINGS

Additional advantages, features and details of the invention may be gleaned from the following description of preferred exemplary embodiments, as well as based on the drawings.

The latter show:

FIG. 1: A diagrammatic view of a first exemplary embodiment of a screw element with two external thread sections spaced axially apart, which only differ in terms of their axial extension, wherein a thread run-out of the first external thread section is offset exclusively via the axial adjustment of the external thread sections relative to each other in the circumferential direction as well as axially with respect to a thread lead-in of the second external thread section,

FIG. 2: An alternative exemplary embodiment, in which the two external thread sections are twisted relative to each other, which realizes a displacement in the circumferential direction of the thread run-out of the first external thread section relative to the thread lead-in of the second external thread section,

FIG. 3: A screw connection with a screw element designed as a head screw,

FIGS. 4a to 4c: diagrammatic depictions showing the sequence of a first alternative manufacturing process.

Identical elements and elements with the same function are labeled with the same reference numbers on the figures.

### DETAILED DESCRIPTION

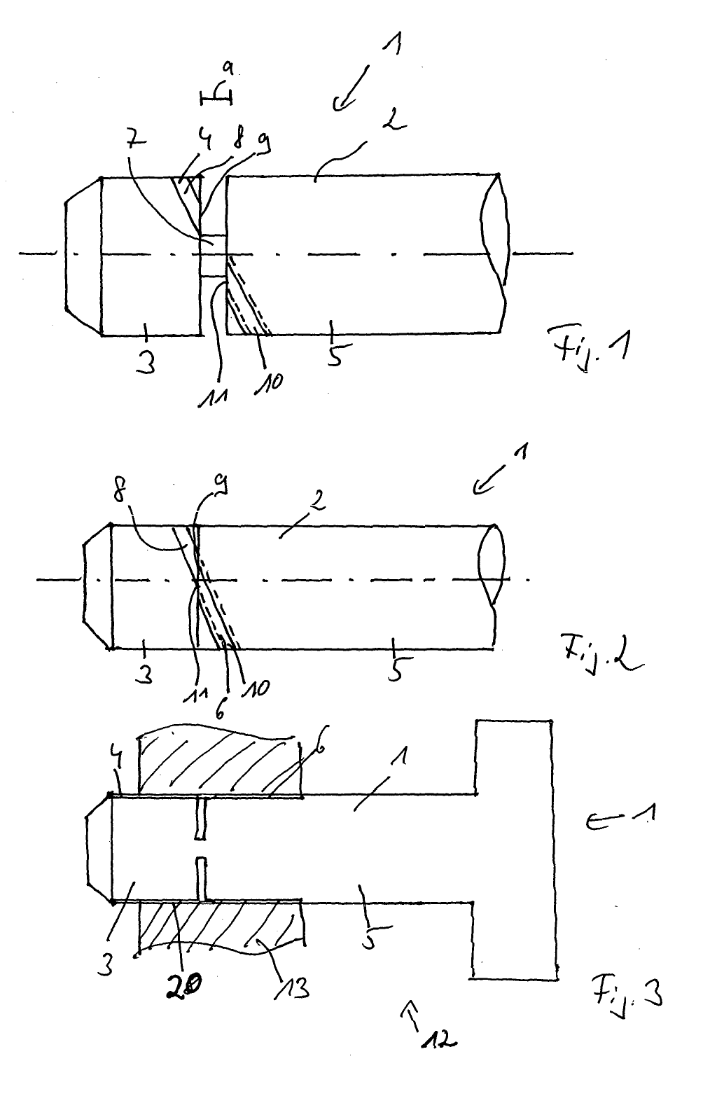

FIG. 1 provides a sectional view of a screw element 1. The screw element 1 encompasses a shank 2 with a first, end-side external thread section 3, which exhibits a first external thread 4. A second external thread section 5 with a second external thread 6 is situated axially adjacent to the first external thread section 3. Both external threads 4, 6 are identical, i.e., they exhibit the same direction of spiral, the same pitch, and the same thread size.

As evident from FIG. 1, the diameter (core and flank diameter) of the two external thread sections 3, 5 is identical. The external thread sections 3, 5 are both molded onto the one-piece shank 2, and joined with each other (as a single piece) via a cylindrical connecting section 7. The connecting section 7 exhibits a smaller diameter than the external thread sections 3, 5, wherein the size of the diameter determines the effect exerted by the spring of the cylindrical connecting section 7 in an axial direction.

The first external thread 4 of the first external thread section 3 encompasses an only partially depicted first thread turn 8, which encompasses a thread run-out 9. The second external thread 6 of the second external thread section 5 encompasses a second, only sectionally depicted thread turn 10 with a thread lead-in 11 facing the first external thread section 3. The thread run-out 9 of the first external thread section 3 is positioned in such a way relative to the thread lead-in 11 of the second external thread section 5 as to yield a braking torque when the external thread sections 3, 5 are tightened with an internal thread element (not shown).

As evident from FIG. 1, a jump in thread pitch is realized between the thread turns 8, 10 of the external thread sections 3, 5. Without a jump in thread pitch, the second thread run 10 would align with the first thread turn 8 in the thread direction, as denoted by the dashed line, and no braking torque would result while tightening the external thread sections 3, 5 with an internal thread element. The distance a between the thread run-out 9 of the first thread section 3 and the thread lead-in 11 of the second thread run 10 differentiates (somewhat) from the pitch of thread turns 8, 10, so that warping in an axial direction arises when the external thread sections 3, 5 are tightened with an internal thread element, thereby resulting in a braking, i.e., safety, torque. As may be gleaned from FIG. 1, the circumferential centers of the thread run-out 9 and thread lead-in 11 are not located precisely at the same circumferential angle, but are rather (somewhat) offset relative to each other in the circumferential direction, thereby realizing the aforementioned jump in thread pitch.

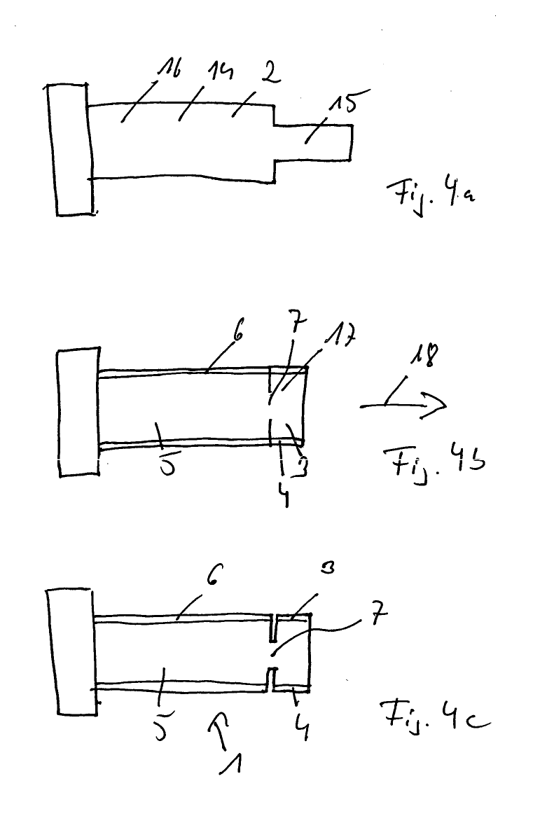

The relative positioning of the thread turns 8, 10 of the external thread sections 3, 5 relative to each other shown on FIG. 1 can be generated by fabricating the circumferential groove (puncture) depicted on FIG. 1 with the width a (in particular a=0.1 mm to about 0.5 mm), but this would require a more (complicated) machining operation. The axial displacement between the external thread sections 3, 5 and resultant circumferential displacement between the thread run-out 9 and thread lead-in 11 was preferably achieved by axially adjusting the external thread sections 3, 5 relative to each other, as will still be explained later based on FIGS. 4a to 4c.

FIG. 2 shows an alternative exemplary embodiment of a one-piece screw element 1 with a shank 2. The external thread sections 3, 5 joined with each other as a single piece with the first and second external threads 4, 6 are in evidence. As in the exemplary embodiment according to FIG. 1, the thread run-out 9 of the first thread turn 8 in the first external thread 4 is (somewhat) displaced in the circumferential direction in relation to the thread lead-in 11 of the second thread turn 10 in the second external thread 6. Prior to relative positioning, the two thread turns 8, 10 align with each other in the thread turn direction, as made evident by the relative position of the second thread section according to FIG. 2 denoted by the dashed line.

In order to realize the exemplary embodiment shown on FIG. 2, the external thread sections 3, 5 were adjusted relative to each other exclusively via warping, for example.

FIG. 3 shows a screw connection 12. The latter encompasses a screw element 1 designed as a head screw, the two external thread sections 3, 5 of which are tightened with a continuous internal thread 18 of a matching internal tread element 13. Displacing the thread run-out 9 of the first external thread 4 (here a nut, not depicted) relative to the thread lead-in 11 of the second external thread 6 yields a braking torque during the tightening process or as a result of the tightening process.

Described below based on FIG. 4a to 4c is a preferred manufacturing procedure for fabricating a screw element 1 designed as depicted on FIG. 1. In a first procedural step, a screw element blank 14 of the kind shown on FIG. 4a is initially fabricated via cold flow compression molding. The screw element blank 14 encompasses a shank 2, which has a stepped configuration. The shank 2 encompasses a first screw element blank section 15 on the end side, and an axially adjacent second axial section 16, wherein the diameter of the screw element blank section 15 is (noticeably) smaller than the diameter of the second axial section 16.

In an ensuing procedural step, the screw element blank section 15 is compression molded in such a way as to reduce its axial extension, while increasing its radial extension, thereby resulting in the end-side, first axial section 17 depicted on FIG. 4b. A thread is preferably introduced into the first axial section 17 and second axial section 16 concurrently with this compression molding operation. The thread can also be introduced in a follow-up rolling or compression molding step. It is crucial that the first external thread section 3 and second external thread section 5 be obtained, which are centrally joined or formed with each other as a single piece over the connecting section 7 that exerts a spring effect. The first external thread 4 of the first axial section 17 and the second external thread 6 of the second axial section 16 are identical except for their axial extension. The two external thread sections 3, 5 abut each other directly at the face, i.e., in an axial direction.

As denoted by the arrow 18 on FIG. 4, the external thread sections 3, 5 are positioned relative to each other via axial adjustment, in this case when pulled apart, in such a way as to yield a braking torque when the screw element 1 is twisted in a matching internal thread element. The axial extension of the connecting section 7 is altered during adjustment, enlarged in the exemplary embodiment shown, as evident from the depiction on FIG. 4c. The axial extension a of the connecting section 7, and hence the axial extension of the gap 21 (circumferential groove), is enlarged from about zero to a value ranging from about 0.1 mm to about 0.5 mm. The result is a screw element 1 in which the screw run-out 9 or (more precisely) the circumferential center of the thread run-out 9 does not lie precisely at the same circumferential angle as the thread lead-in 11 or circumferential center of the thread lead-in 11 of the second external thread 6 in the second external thread section 5. The screw element 1 shown on FIG. 4c is especially suited for applications involving tensile loading, in which the tensile loading is oriented in the same direction as the direction in which the first external thread section 3 on the end side is adjusted relative to the second external thread section 5 during production (see FIG. 4b).

In the exemplary embodiment shown on FIGS. 4a to 4c, the thread run-out 9 and thread lead-in 11 of the external thread 4, 6 are somewhat offset relative to each other in the circumferential direction, without the external thread sections 3, 5 being twisted in relation to each other, although this can be done additionally or alternatively to an axial relative adjustment of the external thread sections 3, 5, if desired.

1-16. (canceled)

17. A method for manufacturing a screw element (1) with a first external thread section (3) and with a second external thread section (5), wherein the screw element (1) to be manufactured is characterized in that the second external thread section (5) is positioned relative to the first external thread section (3) in such a way as to yield a braking torque when tightening the two external thread sections (3, 5) with an internal thread element (13), with the following procedural steps:
the first and second external thread section (3, 5) are positioned relative to each other in such a way as to yield the braking torque while tightening the two external thread sections (3, 5) with an internal thread element (13), wherein
the external thread sections (3, 5) are positioned via a defined, relative adjustment of the external thread sections (3, 5) in an axial direction and/or circumferential direction, wherein
the first external thread (3) is fabricated at a compression molded first axial section (17), and the second external thread section (5) is fabricated at a second axial section (16) of a screw element blank (14) adjacent to the first axial
section (17), and wherein the first axial section (17) is compression molded out of a reduced-diameter screw element blank section (15) by compression molding in the direction of a second axial section (16), in such a way that the diameter of the first axial section (17) corresponds to the diameter of the second axial section (16).

18. The method according to claim 17, wherein thread turns (8, 10) of the first external thread section (3) and second external thread section (5) are introduced during an operation before the external thread sections (3, 5) are adjusted relative to each other.

19. The method according to claim 17, wherein the two external thread sections (3, 5) abut each other prior to relative adjustment of the external thread sections (3, 5) away from each other in another procedural stage.

20. The method according to claim 19, wherein the axial sections (16, 17) are adjusted away from each other, to fabricate a screw element (1) that can be exposed to a tensile stress.

21. A screw element, manufactured according to claim 17, wherein
the second external thread section (5) is positioned relative to the first external thread section (3) in such a way as to yield a braking torque while tightening the two external thread sections (3, 5) with an internal thread element (13), wherein the two external thread sections (3, 5) are joined together by a connecting section (7), which exhibits a smaller diameter than the external thread sections (3, 5), wherein
the selected diameter of the connecting section (7) is such that the connecting section (7) can be compressed in an axially elastic manner while tightening the screw element (1) with a corresponding internal thread element.

22. The screw element according to claim 21, wherein the connecting section (7) can be elastically compressed by at least 0.1 mm.

23. The screw element according to claim 21, wherein the connecting section (7) can be elastically compressed by at least 0.2 mm.

24. The screw element according to claim 21, wherein the connecting section (7) can be elastically compressed by at least 0.3 mm.

25. The screw element according to claim 21, wherein the distance between the external thread sections (3, 5) measures less than 2 mm.

26. The screw element according to claim 21, wherein the distance between the external thread sections (3, 5) measures less than 1 mm.

27. The screw element according to claim 21, wherein the distance between the external thread sections (3, 5) measures less than 0.6 mm.

28. The screw element according to claim 21, wherein the distance between the external thread sections (3, 5) measures between 0.1 and 0.5 mm.

29. The screw element according to claim 21, wherein the diameter of the connecting section (7) measures 20% to 75% of the diameter of the external thread sections (3, 5).

30. The screw element according to claim 21, wherein the diameter of the connecting section (7) measures 25% to 50% of the diameter of the external thread sections (3, 5).

31. The screw element according to claim 21, wherein a thread run-out (9) of the first external thread section (3) is spaced apart from a thread lead-in (11) of the second external thread section (5) in such a way as to realize a jump in thread pitch between the external thread sections (3, 5), and/or that a thread run-out (9) of the first external thread section (3) is spaced axially apart from a thread lead-in (11) of the second external thread section (5).

32. The screw element according to claim 21, wherein a thread run-out (9) of the first external thread section (3) is offset in the circumferential direction relative to a thread lead-in (11) of the second external thread section (5).

33. The screw element according to claim 21, wherein the axial distance between the thread run-out (9) of the first external thread section (3) and the thread lead-in (11) of the second external thread section (5) is larger or smaller than the thread pitch of the first and second external thread section (3, 5), or larger or smaller than an integral multiple of the thread pitch of the first and second external thread section (3, 5).

34. The screw element according to claim 21, wherein the first and second external thread section (3, 5) encompass a metric thread, and/or wherein the pitch and/or thread size of the external thread sections (3, 5) is identical.

35. The screw element according to claim 21, wherein the external thread sections (3, 5) are positioned relative to each other via relative adjustment in an axial and/or circumferential direction.

36. A screw connection (12) encompassing a screw element (1) according to claim 21 and an internal thread element (13), wherein the first and second external thread section (3, 5) of the screw element (1) are tightened with the internal thread element, and held in the internal thread via a braking torque.
